(19) United States
(12) Patent Application Publication
(10) Pub. No.: US 2026/0315952 A1
(43) Pub. Date: Oct. 15, 2026

(54) SINGLE STAGE AND/OR MULTI-STAGE SHORT-PATH EVAPORATOR (SPE)

(71) Applicant: Cargill, incorporated, Wayzata, MN (US)

(72) Inventor: Michael MAIWORM, Hamburg (DE)

(73) Assignee: Cargill, incorporated, Wayzata, MN (US)

(21) Appl. No.: 19/486,122

(22) PCT Filed: May 20, 2024
(86) PCT No.: PCT/US2024/030173

§ 371 Date: Nov. 20, 2025

(30) Foreign Application Priority Data
May 25, 2023 (EP) 23175314.6
Nov. 9, 2023 (EP) 23208933.4

(51) Int. Cl. B01D 1/22; A23D 9/04; B01D 3/10; B01D 5/00; C11B 3/12; C11C 1/10

(52) U.S. Cl. CPC B01D 1/221; A23D 9/04; B01D 3/10; B01D 5/0015; B01D 5/006; C11B 3/12; C11C 1/10

(57) ABSTRACT

The invention concerns a short-path evaporator (SPE) (1), comprising a housing (2) with: at least one evaporation section (4, 28), configured to be kept at an evaporation temperature (T₁), at least one condensation section (6, 29) associated with the at least one evaporation section, configured to be kept at a condensation temperature (T₃), a main inlet (5) for feeding a liquid (26) to be distilled to the at least one evaporation section, a distillate collection device (7) for collecting condensed distillate (8) from the at least one condensation section, a distillate outlet (9) for removing the condensed distillate from the housing, and a main outlet (17) for removing residue (10) from the at least one evaporation section from the housing.

### CROSS-REFERENCE TO RELATED APPLICATIONS

This application claims the benefit of European Application No. 23175314.6, filed May 25, 2023, and European Application No. 23208933.4, filed Nov. 9, 2023, which are hereby incorporated by reference in its entirety.

### FIELD OF THE INVENTION

The present invention relates to a short-path evaporator (SPE), in particular a plate short-path evaporator (SPE), as well as a method for operating such an SPE.

### BACKGROUND

A “Short Path Evaporator” (SPE) is used in the processing of thermally sensitive high-boiling compounds. The advantage of using an SPE is that a low vacuum pressure, as low as 0.001 mbar, can be maintained, which helps to lower the vaporization temperature of components in a mixture. “Wiping” helps to promote turbulence, which in turn enhances heat and mass transfer. However, wiping also increases wear. Also the presence of moving parts increases the risk of rotating shaft sealing leakages. Another limitation of an SPE is the maximum processing capacity size, which at present is limited to 80 m². In this regard, the “plate” SPE as described in patent publication WO 2010/034043 A1 is an interesting alternative. The same goes for EP 0 189 610 A, disclosing a similar, alternative concept in “packed form”. Both SPE's have as an advantage that there are no moving parts. Additionally, these SPE's can incorporate a significantly larger area per volume compared to a “wiped” SPE. However, the performance of such SPE's can still be improved. The present invention therefore seeks to provide an SPE with improved performance.

### SUMMARY OF THE INVENTION

Thereto, in one aspect, the invention relates to a short-path evaporator (SPE), such as a plate SPE, comprising a housing with:
at least one evaporation section, configured to be kept at an evaporation temperature (T₁),), comprising at least one heatable evaporator plate (20) extending vertically in the housing (2),
at least one condensation section associated with the at least one evaporation section, configured to be kept at a condensation temperature (T₃), comprising at least one coolable condensation plate extending vertically in the housing (2),
wherein a lateral distance (d) between the at least one evaporation section (4, 28) and the at least one condensation section (6, 29) is 20-100 mm,
wherein the at least one evaporation section (4, 28) and the at least one condensation section (6, 29) are arranged in an alternating order, with an evaporation section being alternated with a condensation section,
a main inlet for feeding a liquid to be distilled to the at least one evaporation section,
an inlet feed distributor (27) for distributing the liquid (26) over the at least one evaporation section (4, 28), wherein the main inlet (5) connects to the inlet feed distributor (27),
a distillate collection device (7) arranged at a lower end of the at least one condensation section for collecting condensed distillate from the at least one condensation section,
a distillate outlet (9) for removing the condensed distillate from the housing, and
a main outlet (17) for removing residue from the at least one evaporation section from the housing.

Both wiped SPE's and plate SPE's, as described in WO 2010/034043 A1, constitute single stage equilibrium process equipment, because the SPE's are operated at a single targeted evaporation temperature. This can be a disadvantage when purifying mixtures containing contaminants with a lower volatility, which contain highly volatile valuable components. This means that the removal of the contaminant from the mixture cannot be achieved without losing some or all of the more volatile valuable components. An example of this type of mixture is a refined, bleached, deodorized (RBD) edible oil. Removing a relatively less volatile contaminant, such as mineral oil contaminants MOSH/MOAH using a conventional wiped SPE and plate SPE results in the loss of the valuable and more volatile natural antioxidants, i.e., tocopherols and tocotrienols. Another limitation of wiped and plate SPE's may be encountered when valorizing deodorizer distillates, which can be a source of valuable components, such as squalene, tocopherols, and tocotrienols. Since highly volatile free fatty acids (FFA's) are present in the deodorizer distillate stream, single stage SPE results in a dilute concentration of tocopherol/tocotrienols due to the FFA's being collected concurrently. Two or more evaporation stages are needed to achieve the required concentration of valuable components. Using multiple stages, however, increases equipment cost, since several/multiple SPE's are required.

To address such issues, an aforementioned short-path evaporator (SPE) may advantageously comprise a housing with:
a first stage including:
the at least one evaporation section as at least one first evaporation section, configured to be kept at a first evaporation temperature (T₁), with the main inlet being configured for feeding a liquid to be distilled to the at least one first evaporation section,
the at least one condensation section as at least one first condensation section associated with the at least one first evaporation section, configured to be kept at a first condensation temperature (T₃),
the distillate collection device as a first distillate collection device for collecting condensed distillate from the at least one first condensation section,
the distillate outlet as a first distillate outlet for removing the condensed distillate from the first stage and the housing,
wherein residue from the at least one first evaporation section is transported to a second stage for further distillation,
a second stage including:
at least one second evaporation section, configured to be kept at a second evaporation temperature (T₂), being different from the first evaporation temperature, configured for further distilling the residue transported from the at least one first evaporation section,
at least one second condensation section associated with the at least one second evaporation section, configured to be kept at a second condensation temperature (T₄),
a second distillate collection device for collecting condensed distillate from the at least one second condensation section, with a second distillate outlet for removing the condensed distillate from the second stage and the housing, and
the main outlet as a main outlet for removing residue from the at least one second evaporation section and the second stage from the housing.

The above SPE at least partially overcomes the shortcomings of the prior art by constructing a SPE in such a way that it can be used as a multistage SPE, wherein different evaporation temperatures are maintained for the two evaporation sections of the SPE. This enables recovery of valuable components from the mixture to be distilled, such as a deodorizer distillate stream or purification of RBD oil, without losing valuable components, with no need for additional SPE stages or multiple passes.

Below several further preferred features are disclosed. These features are applicable to the SPE as well as to a method for operating such an SPE, both a single stage SPE, as well as a multi-stage SPE.

The SPE, such as a plate SPE, may comprise a pump device for transporting the residue from the first stage to the second stage.

At least one of the at least one evaporation sections may comprise a heatable evaporator plate. Heating may be achieved by means of a heating fluid flowing through an inner cavity/interior of the heatable evaporator plate.

Analogously, at least one of the at least one condensation sections may comprise a coolable condensation plate, which can be cooled by means of a cooling fluid flowing through an inner cavity/interior thereof. Condensed fluid (distillate) can run or flow down at an outer side/exterior/surface of such a condensation plate.

The at least one first evaporation section may be formed by a first heating zone of a heatable evaporator plate and the at least one second evaporation section may be formed by a second heating zone of the same heatable evaporator plate, wherein the residue from the at least one first evaporation section is transported to the at least one second evaporation section by flowing along the heatable evaporator plate. Thus, the same heatable evaporator plate may advantageously be used for creating two evaporation sections, in particular a heatable evaporator plate spanning/extending in/through the at least two stages. A heating fluid having a first heating temperature (T₁) may flow through an inner cavity/interior of the first heating zone. Analogously, a heating fluid having a second heating temperature (T₂) may flow through an inner cavity/interior of the second heating zone.

The at least one evaporation section may be parallel to the at least one condensation section and/or the at least one second evaporation section may be parallel to the at least one second condensation section.

The at least one evaporation section and/or the at least one condensation section may extend vertically in the housing and/or the at least one second evaporation section and/or the at least one condensation section may extend vertically in the housing. Thus, gravity can be advantageously used to collect residue from e.g. the evaporation section(s) and/or to collect distillate from the condensation section(s). The distillate collection device(s) for collecting condensed distillate from the condensation sections may thus be arranged at a lower end of the condensation section(s).

The at least one evaporation section and/or the at least one second evaporation section and/or the at least one condensation section and/or the at least one second condensation section may comprise a thermal pillow plate. Such a thermal pillow plate allows operation in different temperature ranges by usage of e.g. a high-pressure steam or thermal oil in case of evaporation.

The thermal pillow plate preferably has a height of 1-12 m, preferably 2-8 m, more preferably 3-7 m, such as 6 m, for optimum performance. This a.o. depends on the volatility and/or the concentration of the volatile components that are to be removed—as well as on the manufacturability of such plates.

The housing may be configured for operating under vacuum, preferably full vacuum, wherein the housing preferably comprises a connection point for connecting the housing to a vacuum device for operating the housing under vacuum, to help lower the vaporization temperature of components in the mixture. A vacuum pressure lower than 0.01 mbar, such as 0.001 mbar can be used.

Preferably, a lateral distance (d) between the at least one evaporation section and the (i.e. an adjacent) at least one condensation section and/or the at least one second evaporation section and the (i.e. an adjacent) at least one second condensation section is 20-100 mm, preferably 30-80 mm. Normally, with the one or more first evaporation sections/first stage, where the most volatile components are removed, the distance between adjacent evaporation and condensation sections, such as plates, can be larger. For the one or more second or further evaporation sections/second stage, where the least volatile components are removed, the distance between adjacent evaporation and condensation sections, such as plates, can be smaller.

The at least one evaporation section and the at least one condensation section and/or the at least one second evaporation section and the at least one second condensation section may be arranged in an alternating order, with an evaporation section being alternated with a condensation section. Thus, vapour from an evaporation section may directly condensate on an adjacent condensation section, improving process control.

Another aspect of the invention concerns a method for operating an aforementioned single stage SPE, comprising the steps of:
feeding a liquid to be distilled to the at least one evaporation section via the main inlet,
evaporating the liquid at the at least one evaporation section, at the evaporation temperature (T₁),
condensating the vapour from the at least one evaporation section at the at least one condensation section, at the condensation temperature (T₃),
collecting condensed distillate from the at least one condensation section using the distillate collection device,
removing the condensed distillate from the housing via the distillate outlet,
removing residue from the at least one evaporation section from the housing via the main outlet.

Another aspect of the invention relates to method for operating an aforementioned multi-stage SPE, comprising the steps of:
feeding a liquid to be distilled to the at least one first evaporation section via the main inlet,
evaporating the liquid at the at least one first evaporation section, at the first evaporation temperature (T₁),
condensating the vapour from the at least one first evaporation section at the at least one first condensation section, at the first condensation temperature (T₃),
collecting condensed distillate from the at least one first condensation section using the first distillate collection device,
removing the condensed distillate from the first stage and the housing via the first distillate outlet,
transporting the residue from the at least one first evaporation section to the second stage for further distillation,
evaporating the residue at the at least one second evaporation section, at the second evaporation temperature (T₂),
condensating the vapour from the at least one second evaporation section with the at least one second condensation section, at the second condensation temperature (T₄),
collecting condensed distillate from the at least one second condensation section with the second distillate collection device,
removing the condensed distillate from the second stage and the housing via the second distillate outlet, and
removing residue from the at least one second evaporation section and the second stage from the housing via the main outlet.

The method may be used for removing mineral oil contaminants MOSH/MOAH from edible oil,
wherein the liquid to be distilled comprises an edible oil,
wherein the first evaporation temperature (T₁) is 160-220 °C,
wherein the first condensation temperature (T₃) is 60-120 °C,
wherein the second evaporation temperature (T₂) is 220-280 °C,
wherein the second condensation temperature (T₄) is 60-120 °C,
wherein the pressure in the housing is 0.001-0.1 mbar,
wherein a specific feed flow rate is 15-200 kg/m²/h,
wherein the first distillate collection device collects a distillate rich in tocopherols and tocotrienols from the at least one first condensation section,
wherein the second distillate collection device collects a distillate with MOSH/MOAH from the at least one second condensation section to result in edible oil with a reduced content of MOSH/MOAH.

Thus, a distillate rich in tocopherols and tocotrienols can be recovered from the liquid. The method also results in edible oil with reduced content of mineral oil contaminants MOSH/MOAH.

The condensation temperatures T₃, T₄ are so chosen as to prevent solidification/crystallization of components as sterols in some oils, such as rape seed oil. Condensation temperature influences viscosity of the condensate stream. The skilled person will understand that the condensation temperature shall be selected in a way that it is as high as possible to facilitate the removal of the condensate from the condensation plate, but at the same time low enough to prevent re-evaporation. Thus, optimal film thickness can be achieved on the condensation sections, e.g. pillow plates. Retention times can be adjusted by adjusting the lengths of the sections/plates and—if required—by a serial installation of multiple stages with the same temperature conditions.

The method according may also be used for recovering tocopherols and tocotrienols from a deodorizer distillate stream,
wherein the liquid to be distilled comprises a deodorizer distillate stream,
wherein the first evaporation temperature (T₁) is 110-160 °C,
wherein the first condensation temperature (T₃) is 60-120 °C,
wherein the second evaporation temperature (T₂) is 160-220 °C,
wherein the second condensation temperature (T₄) is 60-120 °C,
wherein the pressure in the housing is 0.001-0.1 mbar,
wherein a specific feed flow rate is 15-200 kg/m²/h,
wherein the first distillate collection device collects a distillate rich in free fatty acids (FFA's) from the at least one first condensation section, and
wherein the second distillate collection device collects a distillate rich in tocopherols and tocotrienols from the at least one second condensation section.

Thus, recovery of valuable components from deodorizer distillate stream or purification of refined, bleached and deodorized (RBD) oil is facilitated without losing valuable components, with no need for additional SPE stages or multiple passes.

It should be noted that in addition to first and second stages, third, fourth and even more stages may be included in the housing. This is also part of the inventive concept underlying the present disclosure.

### DETAILED DESCRIPTION

The present invention is elucidated below with a detailed description. When used in these specification and claims, the terms “comprises” and “comprising” and variations thereof mean that the specified features, steps or integers are included. The terms are not to be interpreted to exclude the presence of other features, steps or components.

### List of Definitions

The following definitions are used in the present description and claims to define the stated subject matter. Other terms not cited below are meant to have the generally accepted meaning in the field.

“Evaporation section” as used in the present description means: an element, body or object, or a part thereof, having a surface for evaporating a liquid therefrom at a certain evaporation temperature.

“Condensation section” as used in the present description means: an element, body or object, or a part thereof, having a surface for condensating vapours thereon at a certain temperature.

“Vacuum” means a pressure/vacuum level of 0.001-0.1 mbar.

### BRIEF DESCRIPTION OF THE FIGURES

The present invention is described hereinafter with reference to the accompanying drawings in which embodiments of the present invention are shown and in which like reference numbers indicate the same or similar elements.

FIG. 1 shows a schematic cross-section of a first exemplary embodiment of a plate SPE according to the present disclosure, more specifically a single stage SPE;

FIG. 2 shows a schematic cross-section of a second exemplary embodiment of a plate SPE according to the present disclosure, more specifically a multi-stage SPE;

FIG. 3 shows a schematic close-up view of the first distillate collection device as shown in FIG. 2;

FIG. 4 shows a schematic cross-section of a third exemplary embodiment of a plate SPE according to the present disclosure; and

FIG. 5 shows a schematic cross-section of a fourth exemplary embodiment of a plate SPE according to the present disclosure.

### DETAILED DESCRIPTION OF THE FIGURES

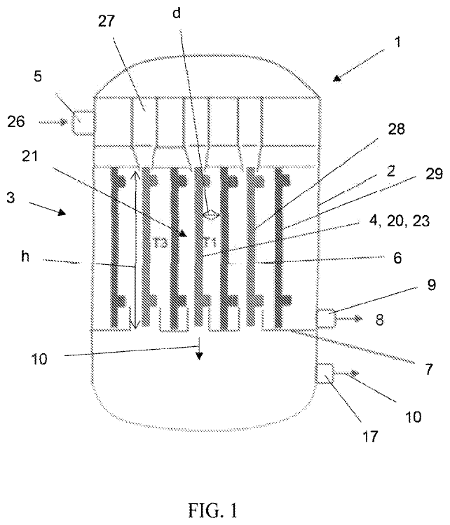

FIG. 1 shows a schematic cross-section of a first exemplary embodiment of a short-path SPE 1 according to the present disclosure, more specifically a single stage plate SPE. The single stage comprises a housing 2 with at least one evaporation section 4, 28, such as two or more, configured to be kept at an evaporation temperature T₁. The housing 2 also comprises at least one condensation section 6, 29, such as two or more, associated with the at least one evaporation section 4, 28 configured to be kept at a certain condensation temperature T₃. The housing 2 furthermore comprises a main inlet 5 for feeding a liquid 26 to be distilled to the at least one evaporation section 4, 28. The housing 2 moreover includes a distillate collection device 7 for collecting condensed distillate 8 from the at least one condensation section 6, 29. A distillate outlet 9 is provided for removing the condensed distillate 8 from the housing 2. A main outlet 17 for removing residue 10 from the at least one evaporation section 4, 28 from the housing 2. Inside the housing 2, the main inlet 5 may connect to an inlet feed distributor 27 for distributing the liquid 26 over the at least one evaporation section 4, 28.

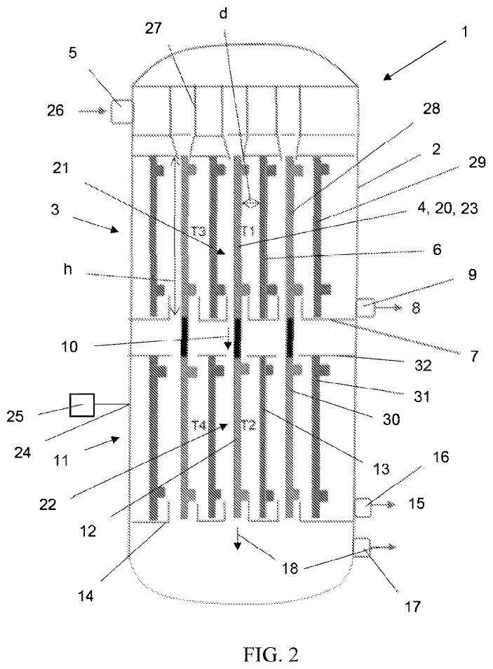

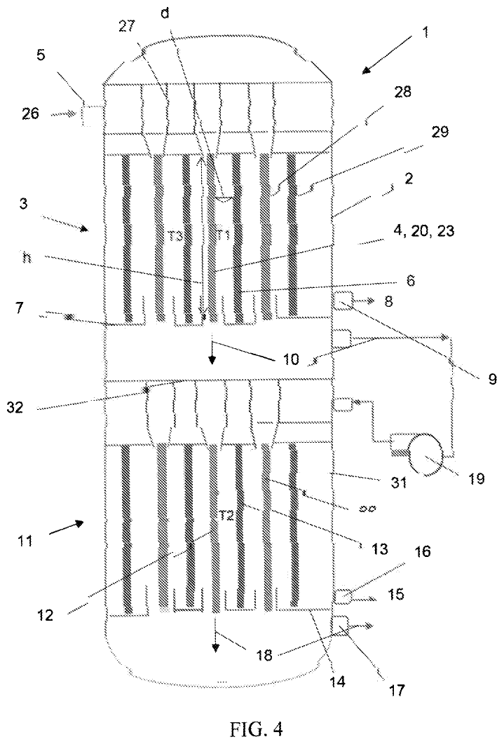

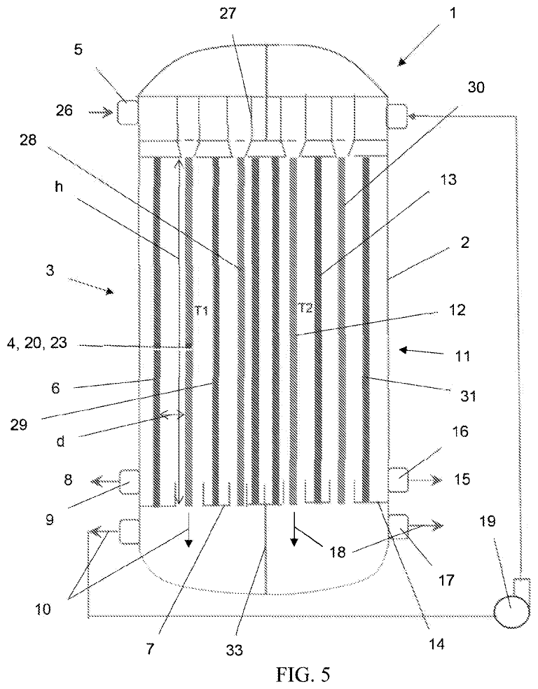

FIG. 2 shows a schematic cross-section of a second exemplary embodiment of a short-path plate SPE 1 according to the present disclosure, more specifically a multi-stage plate SPE. A plate SPE 1 is shown, comprising a housing 2 with a first stage 3 and a second stage 11. The first stage 3 is basically functionally equivalent to the single-stage SPE as depicted in FIG. 1. The first stage 3 and the second stage 11 are positioned vertically adjacent to each other. More specifically, the first stage 3 is arranged above the second stage 11. The same applies to the exemplary embodiment of FIG. 4. As shown in FIGS. 2 and 4, the first stage 3 may be separated from the second stage 11 by a horizontal separation 32, which may be an open separation 32 as shown in FIG. 2, or a closed separation 32 as shown in FIG. 4. In the exemplary embodiment of FIG. 5 the first stage 3 and the second stage 11 are positioned horizontally adjacent to each other. As shown in FIG. 5, the first stage 3 may then be separated from the second stage 11 by a vertical separation 33, for instance a separation plate 33 as shown in FIG. 5. In this case, a distillate collection device 7, 14 shall be constructed in such a way that it allows the collection of two different distillate streams, i.e., stream 8 from the first stage 3, and stream 15 from the second stage 11.

In the exemplary embodiment of FIG. 2, the first stage 3 includes at least one first evaporation section 4, 28 configured to be kept at a first evaporation temperature T₁, with a main inlet 5 for feeding a liquid 26 to be distilled to the at least one first evaporation section 4, 28. The main inlet 5 is preferably arranged in an upper region of the first stage 3. Inside the housing 2, the main inlet 5 may connect to an inlet feed distributor 27 for distributing the liquid 26 over the one or more evaporation sections 4, 28. This is to allow forming and maintaining a closed film over the entire surface, e.g. height, of the evaporation sections 4, 28. The first stage 3 further includes at least one first condensation section 6, 29 associated with the at least one first evaporation section 4, 28, configured to be kept a first condensation temperature T₃. Preferably, the at least one first evaporation section 4, 28 and the at least one first condensation section 6, 29 are arranged adjacent to each other, more preferably horizontally adjacent to each other, such as in an alternating fashion.

The first stage 3 may comprise multiple evaporation sections 4, 28 for improved performance. The evaporation sections 4, 28 may be similar in design. Various configurations are possible. Analogously, the first stage 3 may comprise multiple condensation sections 6, 29 for improved performance. This also applies to the exemplary embodiments shown in FIGS. 1, 4 and 5.

The second stage 11 includes at least one second evaporation section 12, 30, such as at least two, configured to be kept at a second evaporation temperature T₂, being different from the first evaporation temperature T₁, configured for further distilling the residue 10 transported from the first evaporation section 4. The second stage 11 includes at least one second condensation section 13, 31 associated with the at least one second evaporation section 12, 30 configured to be kept at a second condensation temperature T₄. The second condensation temperature T₄ may be different from the first condensation temperature T₃, but the first and second condensation temperatures T₃, T₄ can also be the same. The second stage 11 may comprise multiple evaporation sections 12, 30 and multiple condensation sections 13, 31. The foregoing also applies to the exemplary embodiments shown in FIGS. 1, 4 and 5.

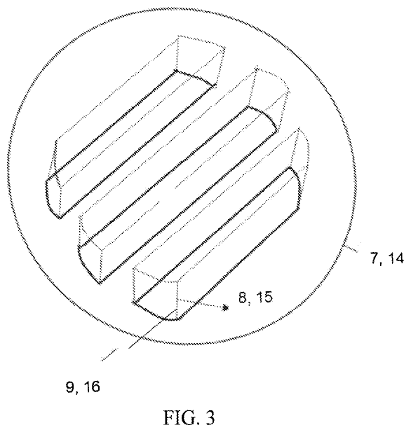

The first stage 3 also has a first distillate collection device 7 for collecting condensed distillate 8 from the at least one first condensation section 6, 29, with a first distillate outlet 9 for removing the condensed distillate 8 from the first stage 3. Residue 10 is transported from the at least one first evaporation section 4, 28 to the second stage 11 for further distillation. In the exemplary embodiment of the plate SPE 1 shown in FIG. 1, this is caused by gravity, i.e. the residue 10 flows downward from the at least one evaporation section 4, 28 of the first stage 3 into or onto the at least one second evaporation section 12, 30 of the second stage 11. The third and fourth exemplary embodiments shown in FIGS. 4 and 5 comprise a pump device 19 for transporting the residue 10 from the first stage 3 to the second stage 11. The second stage 11 of the third and fourth exemplary embodiments shown in FIGS. 3 and 4 may again comprise an inlet feed distributor for distributing the residue 10 over one or more evaporation sections 12, 30.

The second stage 11 also includes a second distillate collection device 14 for collecting condensed distillate 15 from the at least one second condensation section 13, 31 with a second distillate outlet 16 for removing the condensed distillate 15 from the second stage 11. The first distillate collection device 7 and the second distillate collection device 14 may be similar in design. A preferred design is shown in the close-up view of FIG. 3. The distillate collection device 7, 14 may comprise a circular plate with openings, such as slits or the like, at the positions of the evaporation sections 4, 12, 28, 30, allowing residue 10, 18 to fall through, alternated by tray-like portions at the positions of the condensation sections 6, 13, 29, 31 for collecting condensed distillate 8, 15 from the condensation sections 6, 13, 29, 31. The tray-like portions may be formed by e.g. vertical metal sheets enclosing the openings e.g. being welded to the circular plate, effectively forming a boundary between the distillate 8 collected and the residue, thereby preventing the collected distillate 8 from e.g. entering the second stage 11 with the residue 10.

The second stage 11 and/or housing 2 includes a main outlet 17 for removing residue 18 from the at least one second evaporation section 12 and the second stage 11.

At least one of the evaporation sections 4, 12, 28, 30 may comprise a heatable evaporator plate 20.

According to the exemplary embodiment shown in FIG. 2, the at least one first evaporation section 4, 28 may be formed by a first heating zone 21 of a heatable evaporator plate 20 and the at least one second evaporation section 12, 30 is formed by a second heating zone 22 of the same heatable evaporator plate 20. The residue 10 from the at least one first evaporation section 4, 28 is “transported” to the at least one second evaporation section 12, 30 by flowing downwards along the heatable evaporator plate 20 as a result of gravity.

The at least one evaporation section 4, 28 may run parallel to the at least one first condensation section 6, 29 of the first stage 3. The at least one second evaporation section 12, 30 of the second stage 11 may analogously run parallel to the at least one second condensation section 13, 31.

The at least one (first) evaporation section 4, 28, the at least one second evaporation section 12, 30, the at least one (first) condensation section 6, 29 and/or the at least one second condensation section 13, 31 preferably also extend vertically in the housing 2.

The at least one (first) evaporation section 4, 28 the at least one second evaporation section 12, 30, the at least one (first) condensation section 6, 29 and/or the at least one second condensation section 13, 31 may comprise a thermal pillow plate 23. The thermal pillow plate 23 can have a height (h) of 1-12 m, preferably 2-8 m, more preferably 3-7 m, most preferably 5.5-6.5 m, such as 6 m.

The housing 2 is preferably configured for operating under vacuum, preferably full vacuum, wherein the housing preferably comprises a connection point 24 for connecting the housing 2 to a vacuum device 25 for operating the housing 2 under vacuum. All exemplary embodiments as shown in FIGS. 1, 2, 4 and 5 may comprise such a vacuum device 25 (although only illustrated in FIG. 2).

A lateral distance (d) between the at least one first evaporation section 4, 28 and an adjacent at least one first condensation section 6, 29 in the first stage 3 and/or the at least one second evaporation section 12, 30 and an adjacent at least one second condensation section 13, 31 in the second evaporation stage 11 may be 20-100 mm, preferably 30-80 mm.

The at least one (first) evaporation section 4, 28 and the at least one (first) condensation section 6, 29 and/or the at least one second evaporation section 12, 30 and the at least one second condensation section 13, 31 may be arranged in an alternating order, with an evaporation section being alternated with a condensation section. This may apply to all exemplary embodiments as shown in FIGS. 1, 2, 4 and 5.

Per stage 3, 11 there are connections for introducing and removing a heating medium such as thermal oil to each of the evaporator sections 4, 12, 28, 30. Analogously, per stage 3, 11 there are connections for introducing and removing cooling medium such as cooling water to each of the condensations sections 6, 13, 29, 31.

A method for operating an aforementioned single stage plate SPE 1 is also provided, comprising the steps of:
feeding a liquid 26 to be distilled to the at least one evaporation section 4, 28 via the main inlet 5,
evaporating the liquid at the at least one evaporation section 4, 28, at the evaporation temperature T₁,
condensating the vapour from the at least one evaporation section 4, 28 at the at least one condensation section 6, 29, at the condensation temperature T₃,
collecting condensed distillate 8 from the at least one condensation section 6, 29 using the distillate collection device 7,
removing the condensed distillate 8 from the housing 2 via the distillate outlet 9,
removing residue 10 from the at least one evaporation section 4, 28 from the housing 2 via the main outlet 17.

A method for operating an aforementioned multi-stage plate SPE 1 is also provided, comprising the steps of:
feeding a liquid 26 to be distilled to the at least one evaporation section 4, 28 via the main inlet 5,
evaporating the liquid 26 at the at least one evaporation section 4, 28 at the first evaporation temperature T₁,
condensating the vapour from the at least one evaporation section 4, 28 at the at least one first condensation section 6, 29 at the first condensation temperature T₃,
collecting condensed distillate 8 from the at least one first condensation section 6 using the first distillate collection device 7,
removing the condensed distillate 8 from the first stage 3 via the first distillate outlet 9,
transporting the residue 10 from the at least one first evaporation section 4, 28 to the second stage 11 for further distillation,
evaporating the residue 10 at the at least one second evaporation section 12, 30, at the second evaporation temperature T₂,
condensating the vapour from the at least one second evaporation section 12, 30 with the at least one second condensation section 13, 31 at the second condensation temperature T₄,
collecting condensed distillate 15 from the at least one second condensation section 13, 31 with the second distillate collection device 14,
removing the condensed distillate 15 from the second stage 11 via the second distillate outlet 16, and
removing residue 18 from the at least one second evaporation section 12 and the second stage 11 via the main outlet 17.

The method is particularly suitable for removing mineral oil contaminants MOSH/MOAH from edible oil,
wherein the liquid 26 to be distilled comprises an edible oil,
wherein the first evaporation temperature T₁ is 160-220 °C,
wherein the first condensation temperature T₃ is 60-120 °C,
wherein the second evaporation temperature T₂ is 220-280 °C,
wherein the second condensation temperature T₄ is 60-120 °C,
wherein the pressure in the housing 2 is 0.001-0.1 mbar,
wherein a specific feed flow rate is 15-200 kg/m2/h,
wherein the first distillate collection device 7 collects a distillate 8 rich in tocopherols and tocotrienols from the at least one first condensation section 6,
wherein the second distillate collection device 14 collects a distillate 15 with MOSH/MOAH from the at least one second condensation section 13 to result in edible oil with a reduced content of MOSH/MOAH.

The method may also be advantageously used for recovering tocopherols and tocotrienols from a deodorizer distillate stream,
wherein the liquid 26 to be distilled comprises a deodorizer distillate stream,
wherein the first evaporation temperature T₁ is 110-160 °C,
wherein the first condensation temperature T₃ is 60-120 °C,
wherein the second evaporation temperature T₂ is 160-220 °C,
wherein the second condensation temperature T₄ is 60-120 °C,
wherein the pressure in the housing 2 is 0.001-0.1 mbar,
wherein a specific feed flow rate is 15-200 kg/m²/h,
wherein the first distillate collection device 7 collects a distillate 8 rich in free fatty acids (FFA's) from the at least one first condensation section 6, and
wherein the second distillate collection device 14 collects a distillate 15 rich in tocopherols and tocotrienols from the at least one second condensation section 13.

Although certain aspects of the invention have been described, the scope of the appended claims is not intended to be limited solely to these specific aspects. The claims are to be construed literally, purposively, and/or to encompass equivalents. The scope of the present invention is defined by the appended claims. One or more of the objects of the invention are achieved by the appended claims.

### LIST OF REFERENCE NUMERALS

1. Plate short-path evaporator (SPE)
2. Housing
3. First stage
4. (First) evaporation section
5. Main inlet for liquid to be distilled
6. (First) condensation section
7. (First) distillate collection device
8. Condensed distillate from the (first) at least one condensation section
9. (First) distillate outlet
10. Residue from the at least one (first) evaporation section
11. Second stage
12. Second evaporation section
13. Second condensation section
14. Second distillate collection device
15. Condensed distillate from the at least one second condensation section
16. Second distillate outlet
17. Main outlet
18. Residue from the at least one second evaporation section
19. Pump device
20. Heatable evaporator plate
21. First heating zone
22. Second heating zone
23. Thermal pillow plate
24. Connection point
25. Vacuum device
26. Liquid to be distilled
27. Inlet feed distributor
28. (First) evaporation section
29. (First) condensation section
30. Second evaporation section
31. Second condensation section
32. Horizontal separation
33. Vertical separation
T₁, T₂. Evaporation temperature
T₃, T₄. Condensation temperature
h. Height of thermal pillow plate
d. Lateral distance

1. A short-path evaporator (SPE) (1), comprising a housing (2) with:
at least one evaporation section (4, 28), configured to be kept at an evaporation temperature (T₁), comprising at least one heatable evaporator plate (20) extending vertically in the housing (2),
at least one condensation section (6, 29) associated with the at least one evaporation section, configured to be kept at a condensation temperature (T₃), comprising at least one coolable condensation plate extending vertically in the housing (2),
wherein a lateral distance (d) between the at least one evaporation section (4, 28) and the at least one condensation section (6, 29) is 20-100 mm,
wherein the at least one evaporation section (4, 28) and the at least one condensation section (6, 29) are arranged in an alternating order, with an evaporation section being alternated with a condensation section,
a main inlet (5) for feeding a liquid (26) to be distilled to the at least one evaporation section,
an inlet feed distributor (27) for distributing the liquid (26) over the at least one evaporation section (4, 28), wherein the main inlet (5) connects to the inlet feed distributor (27),
a distillate collection device (7) arranged at a lower end of the at least one condensation section for collecting condensed distillate (8) from the at least one condensation section,
a distillate outlet (9) for removing the condensed distillate from the housing,
a main outlet (17) for removing residue (10, 18) from the at least one evaporation section from the housing.

2. The SPE (1) according to claim 1, comprising a housing (2) with:
a first stage (3) including:
the at least one evaporation section (4, 28) as at least one first evaporation section (4, 28), configured to be kept at a first evaporation temperature (T₁), with the main inlet (5) being configured for feeding a liquid (26) to be distilled to the at least one first evaporation section,
the at least one condensation section (6, 29) as at least one first condensation section (6) associated with the at least one first evaporation section, configured to be kept at a first condensation temperature (T₃),
the distillate collection device (7) as a first distillate collection device (7) for collecting condensed distillate (8) from the at least one first condensation section,
the distillate outlet (9) as a first distillate outlet (9) for removing the condensed distillate from the first stage and the housing,
wherein residue (10) from the at least one first evaporation section is transported to a second stage (11) for further distillation,
a second stage (11) including:
at least one second evaporation section (12, 30), configured to be kept at a second evaporation temperature (T₂), being different from the first evaporation temperature, configured for further distilling the residue transported from the at least one first evaporation section,
at least one second condensation section (13, 31) associated with the at least one second evaporation section, configured to be kept at a second condensation temperature (T₄),
a second distillate collection device (14) for collecting condensed distillate (15) from the at least one second condensation section, with a second distillate outlet (16) for removing the condensed distillate from the second stage and the housing, and
the main outlet (17) as a main outlet (17) for removing residue (18) from the at least one second evaporation section and the second stage from the housing.

3. The SPE (1) according to claim 2, comprising a pump device (19) for transporting the residue (10) from the first stage (3) to the second stage (11).

4. The SPE (1) according to claim 1, wherein the at least one first evaporation section (4, 28) is formed by a first heating zone (21) of a heatable evaporator plate (20) and the at least one second evaporation section (12, 30) is formed by a second heating zone (22) of the same heatable evaporator plate (20), wherein the residue (10) from the at least one first evaporation section is transported to the at least one second evaporation section by flowing along the heatable evaporator plate.

5. The SPE (1) according to claim 1, wherein the at least one evaporation section (4, 28) is parallel to the at least one condensation section (6, 29) and/or wherein the at least one second evaporation section (12, 30) is parallel to the at least one second condensation section (13, 31).

6. The SPE (1) according to claim 2, wherein the at least one second evaporation section (12, 30) and/or the at least one condensation section (13, 31) extend vertically in the housing (2).

7. The SPE (1) according to claim 1, wherein the at least one evaporation section (4, 28) and/or the at least one second evaporation section (12, 30) and/or the at least one condensation section (6, 29) and/or the at least one second condensation section (13, 30) comprise a thermal pillow plate (23).

8. The SPE (1) according to claim 6, wherein the thermal pillow plate (23) has a height (h) of 1-12 m, preferably 2-8 m, more preferably 3-7 m, such as 6 m.

9. The SPE (1) according to claim 1, wherein the housing (2) is configured for operating under vacuum, preferably full vacuum, wherein the housing preferably comprises a connection point (24) for connecting the housing to a vacuum device (25) for operating the housing under vacuum.

10. The SPE (1) according to claim 2, wherein a lateral distance (d) between the at least one second evaporation section (12, 28) and the at least one second condensation section (13, 31) is 20-100 mm, preferably 30-80 mm.

11. The SPE (1) according to claim 2, wherein the at least one second evaporation section (12, 30) and the at least one second condensation section (13, 31) are arranged in an alternating order, with an evaporation section being alternated with a condensation section.

12. Method for operating an SPE (1), wherein the SPE is defined according to claim 1, comprising the steps of:
feeding a liquid (26) to be distilled to the at least one evaporation section (4, 28) via the main inlet (5),
evaporating the liquid at the at least one evaporation section, at the evaporation temperature (T₁),
condensating the vapour from the at least one evaporation section at the at least one condensation section (6, 29), at the condensation temperature (T₃),
collecting condensed distillate (8) from the at least one condensation section using the distillate collection device (7),
removing the condensed distillate from the housing via the distillate outlet (9),
removing residue (10, 18) from the at least one evaporation section from the housing via the main outlet (17).

13. Method for operating an SPE (1), wherein the SPE is defined according to claim 2, comprising the steps of:
feeding a liquid (26) to be distilled to the at least one first evaporation section (4, 28) via the main inlet (5),
evaporating the liquid at the at least one first evaporation section, at the first evaporation temperature (T₁),
condensating the vapour from the at least one first evaporation section at the at least one first condensation section (6, 29), at the first condensation temperature (T₃),
collecting condensed distillate (8) from the at least one first condensation section using the first distillate collection device (7),
removing the condensed distillate from the first stage (3) and the housing via the first distillate outlet (9),
transporting the residue (10) from the at least one first evaporation section to the second stage (11) for further distillation,
evaporating the residue at the at least one second evaporation section, at the second evaporation temperature (T₂),
condensating the vapour from the at least one second evaporation section (12, 30) with the at least one second condensation section (13, 31), at the second condensation temperature (T₄),
collecting condensed distillate (15) from the at least one second condensation section with the second distillate collection device (14),
removing the condensed distillate from the second stage and the housing via the second distillate outlet (16), and
removing residue (18) from the at least one second evaporation section and the second stage from the housing via the main outlet (17).

14. Method according to claim 12, for removing mineral oil contaminants MOSH/MOAH from edible oil,
wherein the liquid (26) to be distilled comprises an edible oil,
wherein the first evaporation temperature (T₁) is 160-220 °C,
wherein the first condensation temperature (T₃) is 60-120 °C,
wherein the second evaporation temperature (T₂) is 220-280 °C,
wherein the second condensation temperature (T₄) is 60-120 °C,
wherein the pressure in the housing (2) is 0.001-0.1 mbar,
wherein a specific feed flow rate is 15-200 kg/m²/h,
wherein the first distillate collection device (7) collects a distillate (8) rich in tocopherols and tocotrienols from the at least one first condensation section (6, 29),
wherein the second distillate collection device (14) collects a distillate (15) with MOSH/MOAH from the at least one second condensation section (13, 31) to result in edible oil with a reduced content of MOSH/MOAH.

15. Method according to claim 12, for recovering tocopherols and tocotrienols from a deodorizer distillate stream,
wherein the liquid (26) to be distilled comprises a deodorizer distillate stream,
wherein the first evaporation temperature (T₁) is 110-160 °C,
wherein the first condensation temperature (T₃) is 60-120 °C,
wherein the second evaporation temperature (T₂) is 160-220 °C,
wherein the second condensation temperature (T₄) is 60-120 °C,
wherein the pressure in the housing (2) is 0.001-0.1 mbar,
wherein a specific feed flow rate is 15-200 kg/m²/h,
wherein the first distillate collection device (7) collects a distillate (8) rich in free fatty acids (FFA's) from the at least one first condensation section (6, 29), and
wherein the second distillate collection device (14) collects a distillate (15) rich in tocopherols and tocotrienols from the at least one second condensation section (13, 31).
